(19) United States
(12) Patent Application Publication
(10) Pub. No.: US 2026/0252951 A1
(43) Pub. Date: Aug. 27, 2026

(54) Self-Explaining Decision Architecture and Methods of Use

(71) Applicant: The Board of Regents of the University of Oklahoma, Norman, OK (US)

(72) Inventors: Alex Stringer, Norman, OK (US); Brian Sun, Norman, OK (US); Zackary Hoyt, Norman, OK (US); Lacey D. Schley, Norman, OK (US); Dean F. Hougen, Norman, OK (US); John Antonio, Norman, OK (US)

(21) Appl. No.: 19/102,794

(22) PCT Filed: Sep. 29, 2023
(86) PCT No.: PCT/US2023/034149

§ 371 Date: Feb. 10, 2025

Related U.S. Application Data
(60) Provisional application No. 63/411,490, filed on Sep. 29, 2022.

(51) Int. Cl. G06N 20/00

(52) U.S. Cl. CPC G06N 20/00

(57) ABSTRACT

A Self-Explaining Decision Architecture (SEDA) for machine learning-based decision-making systems capable of generating intuitive explanations for its decisions in real time. SEDA makes use of a feature extraction subsystem and a sequence interpretation subsystem to identify patterns in data followed by a decision generation subsystem that determines appropriate actions based on those patterns. Internal state information from each of these subsystems is used to generate explanations of the system's decisions. Using this information to create explanations provides insight as to the data elements the system focused on when making decisions as well as the reasoning that was used. In at least one embodiment the system uses deep learning components including a combined convolutional neural network and long short-term memory network with attention mechanisms.

### CROSS-REFERENCE TO RELATED APPLICATIONS

Priority is claimed to U.S. Prov. Patent App. No. 63/411,490 filed on Sep. 29, 2022, which is incorporated by reference.

### STATEMENT REGARDING FEDERALLY SPONSORED RESEARCH OR DEVELOPMENT

None.

### BACKGROUND

One goal of artificial intelligence (AI) is to create systems to perform tasks that would otherwise require human intelligence to accomplish. Machine learning (ML) is the branch of AI concerned with creating systems that improve their performance through processing data. With sufficient training, ML systems can rapidly detect patterns in large datasets and use those patterns to produce accurate predictions and classifications.

The aerospace and defense sectors have numerous stochastic optimization problems such as data fusion and auto-routing that would benefit from ML. Data fusion is the process of ingesting, analyzing, and combining data from multiple sources to generate more accurate information than would be possible using any single dataset. Auto-routing is the analysis of large quantities of information about an operational area to identify a potential optimal path to travel along.

The need for improved data fusion is growing as the capabilities of sensors and the platforms on which they reside are advancing rapidly. Sensors have become ubiquitous in virtually all domains, producing unprecedented volumes of data; new types of sensors and associated technologies are being introduced at rates that are truly remarkable. Furthermore, as the environments in which sensor platforms operate become more congested and complicated—combined with increasing requirements for fast and accurate processing—the demands on fusion systems are growing rapidly.

Historically, data fusion in aerospace and defense has been performed by using statistics-based digital filtering techniques. In particular, the Kalman filter and its variants are among the most common and well-known approaches. These methods assume Gaussian distributions in sensor measurements. Traditional digital filtering techniques such as Kalman filtering have severe limitations that impact their utility in the more complex settings and applications needed today. In particular, because they assume known error probability distribution functions, their performance can degrade significantly in the presence of uncertainty not captured by the assumed statistical model. This limits the performance of existing data fusion systems in terms of both accuracy and consistency. Another fundamental shortcoming of traditional filtering techniques is that they are limited to low-level processing of sensor signals, e.g., fusing multiple time series. Finally, while the theory behind traditional statistical techniques like Kalman filtering may be well understood by those who design and implement systems based on them, their behavior may be nonetheless uninterpretable by operators of these systems. AI/ML techniques do not necessarily rely on restrictive statistical assumptions, do not offer possibilities for symbolic computing, and can be designed to be self-explaining, enabling higher-level data processing, fusing, and interpretation.

Likewise, aircraft routing relies on analysis of large quantities of data about an operational area to identify potential paths for aircraft to travel along. Currently, most aircraft routing in aerospace and defense is heavily reliant on human involvement. This is due to a number of factors, including safety, passenger and operator trust, and government regulations. ML techniques have been used successfully for fully autonomous dynamic routing of unmanned aerial vehicles. It has also been applied to a more limited degree to generate initial routes and schedules for manned aircraft. However, the safety-critical nature of dynamic routing of manned aircraft in real time has prevented it from being fully automated, instead relying on human operators and pilots to make critical operational decisions. This reliance on human involvement can result in the generation of non-optimal flight paths and reduces the speed with which responses can be made to changes in the operational area. The use of ML to improve data fusion and more fully automate routing has the potential to improve the safety of aircraft operations, reduce operational costs, reduce operator burden, and drastically improve response time to changing conditions. These benefits, coupled with the vast quantities of available training data, make these important focus areas for the application of ML in avionics.

One limiting factor to the broad incorporation of ML in avionics is interpretability, which is the degree to which the workings of the system are inherently understandable by people. ML is a powerful tool, but the sheer number of calculations performed by ML systems and the often nonintuitive nature of those calculations can make their outputs difficult to understand or verify in real time. Although a well-trained ML system can often perform an analysis much more quickly and accurately than a person, the lack of transparency into how the solution was derived often limits the trust placed in these systems. In addition, inability to readily identify or mitigate issues within ML systems in real time limits their use in critical areas like automated routing or adaptively altering/recommending operational objectives.

The need for ethical decision-making that follows legal and safety requirements in applications such as these, where a machine may be making decisions that affect the health or well-being of humans, has begun to give rise to government regulations requiring that explanations of the machine's decisions be made available upon request to those that are substantially affected by them. This gives rise to a number of challenges to be addressed in the coming years. In particular, it will need to be determined what constitutes a sufficient explanation for those that are impacted by the decisions of ML systems who are not experts in the field and on what time frame those explanations need to be provided.

In an effort to address these issues, interpretability in autonomous systems has become a major focus area for ML researchers in recent years. Research has generally focused on either using simpler ML techniques that are inherently interpretable or generating explanations for the determinations made by more complex systems. The former approach is the most straightforward and has the least overhead; however, ML techniques that are inherently interpretable may not be appropriate for applications that require complex analysis of large feature sets, requiring the use of complex, opaque ML approaches like deep neural networks (DNNs). To address the issue of explaining DNN determinations, significant research has been done into the use of attention mechanisms (AMs) which utilize state matrices within a network to track the impact that each input feature has on the system's output, effectively identifying what the system was paying attention to during operation. AMs have proven to be highly effective at increasing the level of transparency in DNNs.

For generating decisions such as aircraft paths or recommended operational objectives, AMs alone may not provide sufficient information to the operator. It can explain what a system is paying attention to, but not why that observation translates into a given decision. In recent years, there has been a drive to expand the scope of explanations in decision-making DNNs to include a reasoning component as well as an AM. In a real-world operational setting, fully autonomous avionics systems will need to generate decision explanations that are easily understood in real-time. It is to addressing this need and others that the present disclosure is directed.

### BRIEF DESCRIPTION OF THE DRAWINGS

FIG. 1 shows a high-level diagram of the Self-Explaining Decision Architecture (SEDA) of the present disclosure.

FIG. 2 shows a non-limiting embodiment of a SEDA feature-extraction subsystem.

FIG. 3 shows a non-limiting embodiment of a SEDA sequence-interpretation subsystem.

FIG. 4 shows a non-limiting embodiment of a SEDA decision-hierarchy subsystem.

FIG. 5 shows a non-limiting embodiment of a SEDA explanation-generation subsystem.

FIG. 6A shows an example of an original MNIST input data item.

FIG. 6B shows the MNIST input data item in FIG. 6B divided into a sequence of sub-images.

FIG. 7A shows a non-limiting embodiment of a custom input data item showing a complete image.

FIG. 7B shows the custom input data item in FIG. 7A showing a sequence of images.

FIG. 8A shows a non-limiting embodiment of a time series of a chevron “away” image.

FIG. 8B shows a non-limiting embodiment of a time series of a chevron “toward” image.

FIG. 9A shows a non-limiting embodiment of a time series of a cross “away” image.

FIG. 9B shows a non-limiting embodiment of a time series of a cross “toward” image.

FIG. 10 shows a non-limiting embodiment of an explanation generated by a SEDA prototype.

FIG. 11A shows a non-limiting embodiment of an MNIST-based image sequence attention showing a heat map of CBAM attention from a first convolutional layer.

FIG. 11B shows the MNIST-based image sequence attention in FIG. 11A showing a heat map of CBAM attention from a second convolutional layer.

FIG. 11C shows the MNIST-based image sequence attention in FIG. 11A showing a heat map of CBAM attention from a third convolutional layer.

FIG. 11D shows the MNIST-based image sequence attention in FIG. 11A showing a heat map of Luong attention for LSTM.

FIG. 12A shows a non-limiting embodiment of a time-series image sequence attention showing a heat map of CBAM attention from a first convolutional layer.

FIG. 12B shows the time-series image sequence attention in FIG. 12A showing a heat map of CBAM attention from a second convolutional layer.

FIG. 12C shows the time-series image sequence attention in FIG. 12A showing a heat map of CBAM attention from a third convolutional layer.

FIG. 12D shows the time-series image sequence attention in FIG. 12A showing a heat map of Luong attention for LSTM.

### ABBREVIATIONS

AI: artificial intelligence
AM: attention mechanism
BMI: brain-machine interface
C2: command and control
CBAM: Convolutional block attention module
CNN: combined convolutional neural network
DNN: deep neural networks
LSTM: long short-term memory
ML: Machine learning
MLP: multi-layer perceptron
MNIST: Modified National Institute of Standards and Technology
ReLU: rectified linear
SEDA: Self-Explaining Decision Architecture

### DETAILED DESCRIPTION

The present disclosure is directed to a novel Self-Explaining Decision Architecture (SEDA) for an ML-based data-fusion and decision-making system capable of generating intuitive explanations for its decisions in real time. In one non-limiting embodiment, a SEDA is disclosed that makes use of a combined convolutional neural network (CNN) and long short-term memory (LSTM) deep neural network (DNN) with attention mechanisms (AMs) to fuse both spatial and temporal data. The DNN is followed by a decision hierarchy that recommends actions based on the output from the CNN-LSTM DNN. Finally, both the system attention and the path through the decision hierarchy are used to output an explanation of the system's decisions. Using these two elements to create decision explanations is intended to provide information on the data elements the system focused on when making a decision as well as the reasoning that was used to select the recommended course of action. SEDA thereby provides a new framework for providing ML interpretability, and seeks to emulate the way people explain their decisions, improving utility by enabling users to rapidly understand the system's outputs. SEDA is a general architecture, capable of supporting a wide range of applications. In at least one embodiment further described herein, the SEDA implementation targets intelligent data fusion and automated routing for aerospace applications.

In certain embodiments, the presently disclosed self-explaining decision architecture can be used in areas other than aerospace and defense avionics. For example, the system can be integrated into increasingly complex and critical areas, such as decision making in the business and manufacturing domains, where unidentified inefficiencies resulting from a lack of transparency into how ML models make decisions can cause massive financial losses or inadvertently introduce safety violations. The presently disclosed system can be used in the insurance and medical sectors to identify potential treatments, minimize risk, and inform claim decisions. In such fields unknown bias can result in unethical, hazardous, or potentially illegal decisions that have major impacts on peoples' lives. The presently disclosed system can also be incorporated into a broad range of control systems for vehicles, power systems, and machinery, which can cause similar catastrophic issues if their decisions cannot be understood and corrected when necessary.

Before further describing various embodiments of the apparatus, component parts, and methods of the present disclosure in more detail by way of exemplary description, examples, and results, it is to be understood that the embodiments of the present disclosure are not limited in application to the details of apparatus, component parts, and methods as set forth in the following description. The embodiments of the apparatus, component parts, and methods of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the apparatus, component parts, and methods of the present disclosure have been described in terms of particular embodiments, it will be apparent to those of skill in the art that variations may be applied to the apparatus, component parts, and/or methods and in the steps or in the sequence of steps of the method described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms and phrases, unless otherwise indicated, shall be understood to have the following meanings: The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The phrase “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the apparatus, composition, or the methods or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example.

The terms “about” or “approximately”, where used herein when referring to a measurable value such as an amount, percentage, temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. A range is intended to include any sub-range therein, although that sub-range may not be explicitly designated herein. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 2-125 therefore includes 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, and 125, as well as sub-ranges within the greater range, e.g., for 2-125, sub-ranges include but are not limited to 2-50, 5-50, 10-60, 5-45, 15-60, 10-40, 15-30, 2-85, 5-85, 20-75, 5-70, 10-70, 28-70, 14-56, 2-100, 5-100, 10-100, 5-90, 15-100, 10-75, 5-40, 2-105, 5-105, 100-95, 4-78, 15-65, 18-88, and 12-56. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure. More particularly, a range of 10-12 units includes, for example, 10, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, and 12.0, and all values or ranges of values of the units, and fractions of the values of the units and integers within said range, and ranges which combine the values of the boundaries of different ranges within the series, e.g., 10.1 to 11.5. Reference to an integer with more (greater) or less than includes any number greater or less than the reference number, respectively. Thus, for example, reference to less than 100 includes 99, 98, 97, etc. all the way down to the number one (1); and less than 10 includes 9, 8, 7, etc. all the way down to the number one (1).

The following definitions of the terms used herein apply:
“Semiautonomous system” refers to a system that can perform some portion of its functions independently but requires human intervention/operation for standard operation.
“Fully autonomous system” refers to a system that can perform all of its functions independent of human intervention or operation.
“Attention mechanism” refers to a system either used in conjunction with or integrated into an ML model that identifies the impact input data has on the model output. Attention mechanisms are associated with entire or specific sections of a machine learning model and measure how strongly those sections are activated by different inputs. Those inputs that strongly activate that portion of the model are deemed to be “more important” to that region than those that activate it less.
“Structured decision” refers to a decision that has known relationships to other decisions (either parallel or tiered) that are consistent and can be represented. For instance, “I want to start my car, so I need to both compress the brake pedal and turn the key simultaneously.” is a set of structured decisions that can consistently be represented as Start Car=Compress Brake+Turn Key.
“Explanation” refers to a rationale or reason(s) for making a decision. For example, an explanation can contain information on the reasoning behind a decision and the information that was primarily used to arrive at that decision.
“Course of action” refers to a set of one or more actions that can be taken automatically or manually in a given scenario.
“Non-sequential pattern” refers to a pattern that does not depend on the order in which observations are made or on the order in which elements occur.
“Feature extraction system” refers to a system that identifies non-sequential patterns in data.
“Sequential pattern refers to a pattern that does depend on the order in which observations are made or on the order in which elements occur.
“Sequence interpretation system” refers to a system that identifies sequential patterns in data.
“Spatial pattern” refers to a pattern that pertains to the relationships between one or more entities in a physical space.
“Temporal pattern” refers to a pattern that pertains to relationships between one or more entities in time.
“Inter-related parallel decision” refers to a decision that is made in conjunction with and impacts another decision either directly or indirectly. For instance, “In order to achieve C, I must now do A and B” or “I am in the process of doing A, so I should also do B.”
“Tiered or hierarchical decision” refers to a decision that can be broken down into derivative elements. For instance, “I would like to do E, which is comprised of C and D, and C is in turn comprised of A and B.”
“Consistently defined relationship” refers to a relationship that either does not change or changes in a known and well-defined way.
“Level of certainty” refers to the degree of confidence that a particular feature is contained within a particular pattern.
“Level of importance” refers to the degree to which a portion of the ML model is activated by data or features and is measured using the attention mechanisms. Because ML systems often learn in non-deterministic ways, the importance of an input or feature is typically measured relative to the other inputs or features when generating explanations. For example, for a given set of inputs, the most important one is the one with the highest activation values and the least important one is the one with the lowest activation values.

Deep learning generally refers to methods that map data through multiple levels of abstraction, where higher levels represent more abstract entities. The goal of deep learning is to provide a fully automatic system for learning complex functions that map inputs to outputs, without using hand crafted features or rules. One implementation of deep learning comes in the form of feedforward neural networks, where levels of abstraction are modeled by multiple non-linear hidden layers.

Any of the methods described herein can be totally or partially performed with a computer system including one or more processors, which can be configured to perform the operations disclosed herein. Thus, embodiments can be directed to computer systems configured to perform the operations of any of the methods described herein, with different components performing a respective operation or a respective group of operations. Although presented as numbered operations, the operations of the methods disclosed herein can be performed at a same time or in a different order. Additionally, portions of these operations can be used with portions of other operations from other methods. Also, all or portions of an operation can be optional. Additionally, any of the operations of any of the methods can be performed with modules, units, circuits, or other approaches for performing these operations.

The present disclosure will now be discussed in terms of several specific, non-limiting, examples and embodiments. The examples described below, which include particular embodiments, will serve to illustrate the practice of the present disclosure, it being understood that the particulars shown are by way of example and for purposes of illustrative discussion of particular embodiments and are presented in the cause of providing what is believed to be a useful and readily understood description of procedures as well as of the principles and conceptual aspects of the present disclosure.

### I. Self-Explaining Decision Architecture

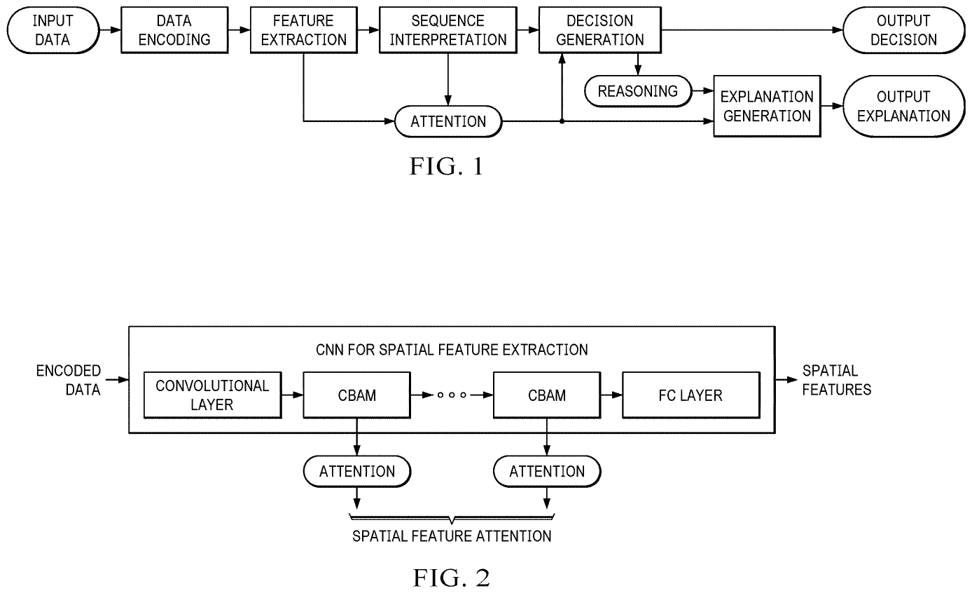

As illustrated in one non-limiting embodiment in FIG. 1, SEDA is a novel architecture designed to generate both high-fidelity decisions and intuitive explanations for those decisions. It comprises five primary subsystems: data encoding, feature extraction, sequence interpretation, decision generation, and explanation generation.

An explanation of a system of the present disclosure may be communicated (expressed, delivered) to the user via one or more of a visual (seeing, graphic) mode, an aural (hearing) mode, a tactile (touch) mode, a taste (gustatory) mode, and an olfactory (smell) mode. Visual modes using, for example, but not by way of limitation, writing or other meaningful symbols or designs, may be expressed on any appropriate device accessible to the user, such as, but not limited to, a monitor, a smartphone screen, a tablet, a laptop, a hologram, or a virtual reality headset. Aural modes include not only verbal speech, but also non-speech sounds such as alarms, or other sounds that contain information. Explanations which are expressed via a non-visual or non-aural sense, such as touch, taste, or smell, may be employed to accommodate a user who has impaired sight (visual) or hearing (aural) ability, or is incapacitated in some other manner. An explanation may also be delivered to a user's brain via a direct interface with the brain, or a brain-machine interface (BMI). An explanation may include one or more or all of the modes of communication/expression listed above, in any combination.

The feature-extraction and sequence-interpretation subsystems together form a compound module for detecting patterns in spatiotemporal data. SEDA is designed for processing spatiotemporal data due to its broad applicability to intelligent systems in avionics, and specifically to the realms of data fusion and aircraft routing. However, it is worth noting here that the approach to system intelligence and interpretability presented in this paper is applicable to many other domains.

### A. Data-Encoding Subsystem

The data-encoding subsystem performs any preprocessing needed to ensure that the data is ready to be passed into the feature extraction component of SEDA. It includes operations like data cleaning and encoding non-numeric information. The exact preprocessing performed by the data-encoding sub-system will vary depending on the application, so it is not discussed in detail here, although an exemplary implementation of this subsystem is described below.

### B. Feature-Extraction Subsystem

The feature-extraction subsystem serves to identify key features in the data that can be used in the decision-making process. These features are then passed on to the sequence-interpretation subsystem. It is also responsible for keeping track of and passing along information about what the subsystem was paying attention to when it was extracting features. This attention information is used to help determine the level of certainty that key features are present, generate decision explanations, and may also be used directly by the decision-generation subsystem in the decision-making process.

### C. Sequence-Interpretation Subsystem

The sequence-interpretation subsystem serves to allow SEDA to identify patterns in sequential data, such as time-series data. It enables more complex datasets to be used and more complex decisions to be made. The observed patterns are provided to the decision-generation subsystem to initiate the decision-making process. This subsystem is also responsible for tracking the impact of each entry in the sequence on the patterns it identifies. That information is used by the explanation-generation subsystem to help explain the decisions that are made and is made available to the decision-generation subsystem for possible use in the decision-making process. Note that SEDA is still applicable when sequential data is not used by simply assuming a sequence length of one.

### D. Decision-Generation Subsystem

Together, the data encoding, feature extraction, and sequence-interpretation subsystems seek to emulate the way in which people make observations by taking in information, processing it, and detecting patterns. They are followed by the decision-generation subsystem, which seeks to emulate the way in which people make decisions based on their observations. It achieves this by breaking down complex decisions into a collection of simpler ones from which it selects based on the specific patterns that have been observed in the data as well as contextual information garnered from what the previous subsystems deemed to be important. The decision-generation subsystem is designed to provide some underlying reasoning behind its decision-making process and uses observations from the sequence-interpretation subsystem along with the attention information (collected by both the feature extraction and sequence-interpretation subsystems) to make decisions based on the level of certainty that particular features are present in the data. The decision-generation subsystem also records the reasoning behind its decisions and provides that information to the explanation-generation subsystem. The subsystem's decision can then either be provided as a recommendation to the operator (user) of the system or directly executed, depending on the application and level of autonomy desired.

### E. Explanation-Generation Subsystem

Finally, the combination of system attention and system reasoning are provided to the explanation-generation subsystem. The structure and complexity of this subsystem will vary significantly depending on the application and implementation. However, notional performance might involve generating decision reasoning to explain why a particular decision was reached. For example, in the avionics domain: “HAZARD DETECTED IN PATH→RECOMMEND ALTERING COURSE→RECOMMEND STEERING 10 DEGREES WEST.” If further explanation is desired, attention may be used to tell the operator what the system was focusing on when it made a given decision. Building on the previous example: “STORM DETECTED 25 MILES NORTHWEST; GIVEN ITS RECENT BEHAVIOR IT IS EXPECTED TO ENTER OUR PATH.”

### II. Preliminary SEDA Implementation

This section describes a nonlimiting implementation of SEDA intended to be used as a decision recommendation system for airborne command and control (C2), which refers to the process used to analyze situational information and optimize the allocation of resources to accomplish airborne tasks. This initial embodiment makes use of all components of SEDA from end to end, but has been designed and implemented for limited, though representative, test cases.

This embodiment was developed using Python and Tensorflow. It has been tested both with the openly available and often-used Modified National Institute of Standards and Technology (MNIST) image dataset and with a simulation time-series image dataset developed in Matlab. Each of these datasets uses only a single channel (grayscale). Due to the nature of the architecture and the relative simplicity of the data used for testing, minimal modification of the initial system was required for each set of tests.

### A. Data Encoding Implementation

The initial embodiment of the data-encoding subsystem utilized minimal preprocessing. In the case of the MNIST images, this subsystem divides each image into four sub-images then arranges the sub-images into a sequence because images inherently contain spatial data but not sequential data. In the case of the simulated time-series data, no encoding is necessary as this data was custom generated for testing this initial embodiment.

### B. Feature Extraction Implementation

The feature-extraction subsystem of the initial embodiment is implemented as an attention-based CNN. In this implementation, the CNN is used to learn relevant spatial relationships in the data, which are then passed to the sequence-interpretation subsystem as features. It utilizes multi-layer attention in the CNN, as depicted in FIG. 2. Convolutional block attention modules (CBAMs) are placed after various convolutional layers in the CNN to gather attention information from the network. Each CBAM layer generates two attention masks, one that reflects the overall importance of each kernel in the preceding convolutional layer and one that reflects the importance of each pixel. These masks are multiplied together to generate a D×W×H attention matrix, where D is the equal to the number of kernels in the preceding convolutional layer, and W and H are, respectively, the number of pixels in the height and width dimensions of the image at that point in the network. Each time a sequence is passed through the system the spatial attention matrix is saved as part of the system attention. Only one attention layer would be necessary to satisfy the requirements of SEDA, but utilizing multiple attention layers enables more thorough explanations to be generated through the analysis of simpler and more complex forms of attention.

### C. Sequence Interpretation Implementation

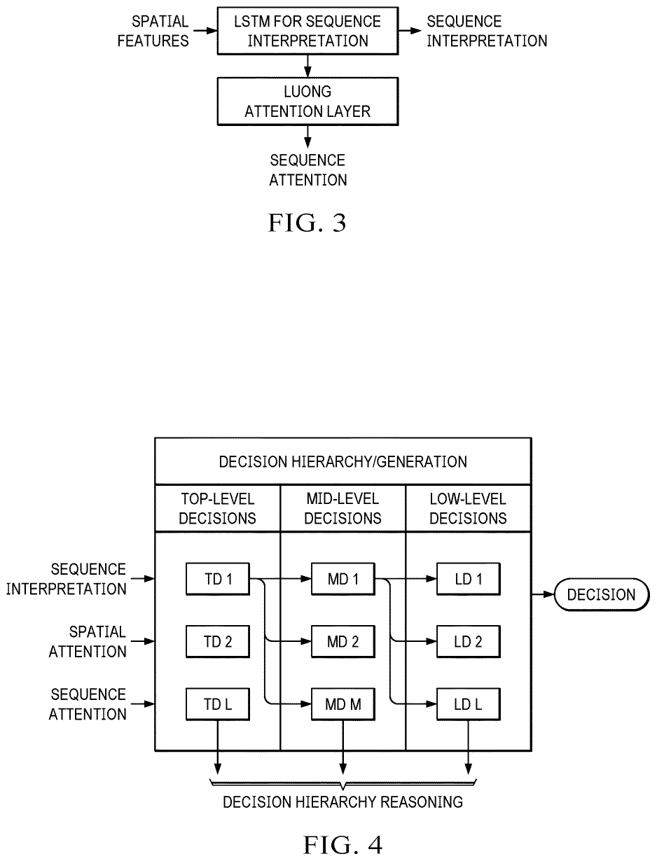

The sequence-interpretation subsystem in the initial embodiment comprises an LSTM network with Luong attention, as shown in FIG. 3. The LSTM ingests feature maps, learns temporal relationships, and makes classifications based on those relationships. The AM enables the LSTM to learn sequential relationships that may include gaps and serves as another element in the generation of explanations.

### D. Decision Generation Implementation

The decision-generation subsystem in the initial embodiment uses a decision hierarchy. Decision hierarchies allow systems a certain degree of freedom to decide between multiple possible actions in a given situation, rather than enforcing a strict decision path. Their hierarchical nature also makes the underlying reasoning behind decisions possible to verify by referring to the path(s) traversed through the decision hierarchy. The implementation is depicted in FIG. 4.

The initial embodiment comprises a three-layer hierarchy. Each layer utilizes a simple feedforward, fully connected DNN with two hidden layers to arrive at its decisions. The DNNs are trained to interpret attention information to recognize key contextual details in the data, produce a human-comprehendible (e.g., human-readable) message explaining its interpretation of the provided attention information, and arrive at a decision based on the combination of those contextual details and the output of the previous layer of the hierarchy. This emulates the way people make decisions based on observations of the world around them by breaking down complex or abstract decisions into a series of increasingly simple ones and selecting a course of action from amongst their perceived options based on the current context.

### E. Explanation Generation Implementation

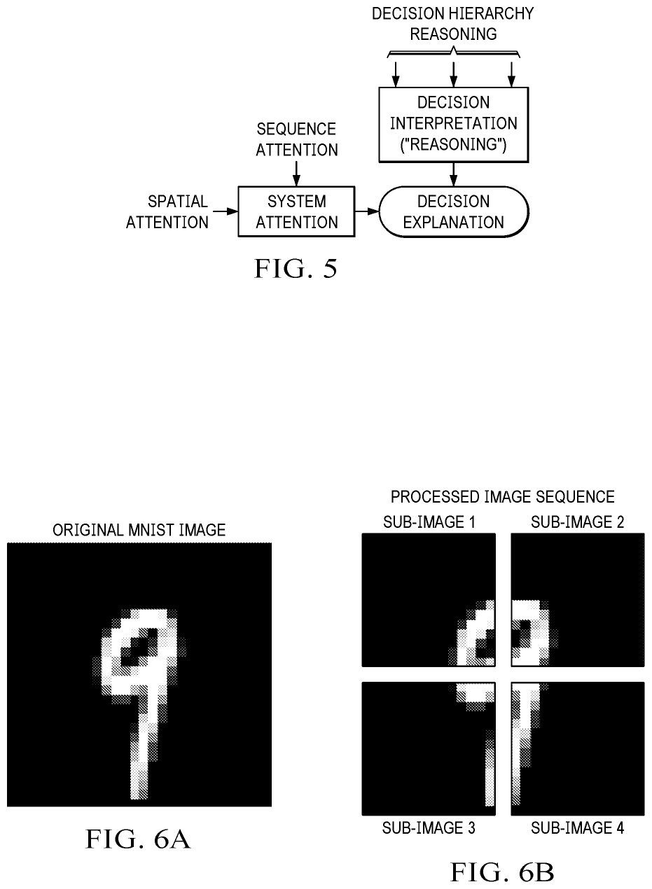

This subsystem uses the combination of attention and reasoning to provide real-time, human-comprehendible explanations of system decisions. A high-level view is shown in FIG. 5. The decision reasoning, based on the path traversed through the decision hierarchy, is used to explain why a particular decision was reached. An example of this is:

“HAZARD DETECTED IN PATH→RECOMMEND ALTERING COURSE

→RECOMMEND STEERING 10 DEGREES WEST.” If further explanation is desired, attention will be used to tell the operator what the system was focusing on when it made a given decision. Building on the previous example: “STORM DETECTED 25 MILES NORTHWEST; GIVEN ITS RECENT BEHAVIOR IT IS EXPECTED TO ENTER OUR PATH.”

### III. Experimental Set Up

In one embodiment of the work as presently described, two datasets are used to empirically evaluate the performance of SEDA; for both datasets, the input to the system is structured as sequences of images. In the case of the MNIST dataset, the data-encoding subsystem divides each 1×28×28 (Depth×Width×Height) grayscale image of a handwritten numeral into four 1×14×14 sub-images as shown in FIGS. 6A-6B for a numeral ‘9,’ and each group of four sub-images is treated as a single sequence.

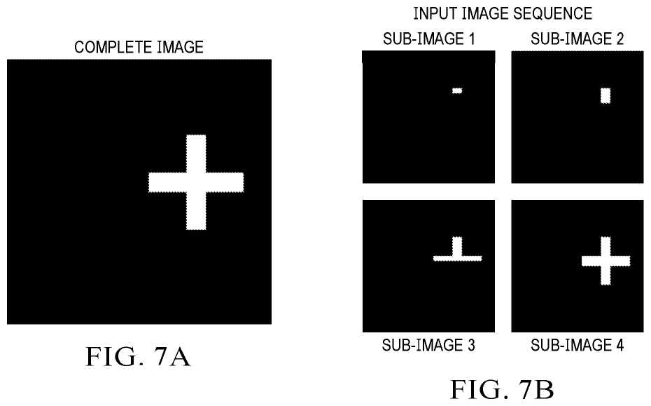

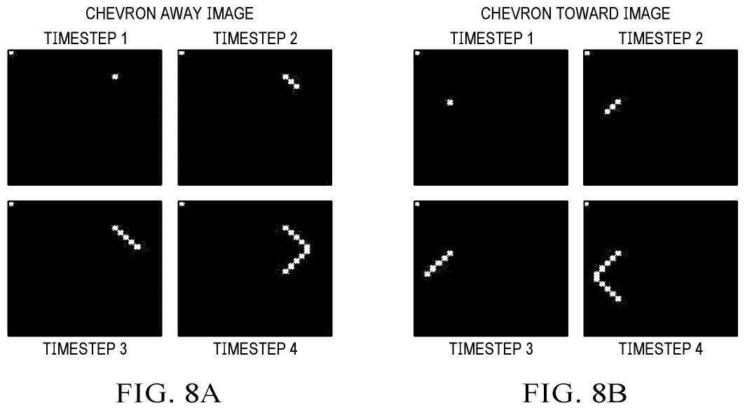

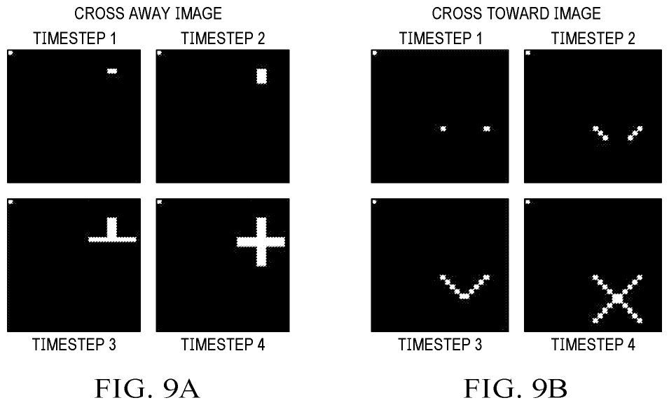

For the custom time-series dataset, each complete image is 1×28×28 within which is a 10×10 sub-image for one of two targets: cross or chevron. Here each timestep is a 1×28×28 snapshot of the target being progressively rendered from top to bottom, giving the system more complete information about the target over time as shown in FIGS. 7A-7B for a cross target.

For each dataset, 60,000 images were used for training and 10,000 images were used for validation using four sets of labels for each image sequence.

The first set of labels are classification labels for the original images used to train the DNN that comprises the feature-extraction and sequence-interpretation subsystems. These labels are pulled directly from the datasets. In the MNIST case these are just the digits 0-9. For the time-series data, the first set of labels classify the object in the sequence as well as its orientation. The four classes are: chevron toward, chevron away, cross toward, and cross away. The orientation of the shape was used to determine whether the shape was moving toward or away from the top left corner. For instance, a chevron with the central point up or to the left is labeled “toward” and a chevron pointed down or to the right is labeled “away.” An upright cross means the target is traveling toward and a diagonal cross (saltire) means the target is traveling away as shown in Table I.

TABLE I
Custom Data Set Labels

| Shape | Orientation | Label |
|---|---|---|
| Chevron | away | 0 (Hostile-away) |
| Chevron | toward | 1 (Hostile-toward) |
| Cross | away | 2 (Friendly-away) |
| Cross | toward | 3 (Friendly-toward) |

Representative example images used for chevron are shown in FIGS. 8A-8B, and for cross are shown in FIGS. 9A-9B. Additionally, three sets of labels were created based on a combination of properties in each image and the desired output of the previous layer of the decision hierarchy (or the output of the LSTM in the case of the first layer of the decision hierarchy). These three label sets are used to both train the system how to navigate the decision hierarchy and to interpret specific contextual information from the image sequence when doing so. In essence, these labels are used to teach the system to interpret its attention information and to establish its method of reasoning through decisions. That makes the selection of these labels and subsequent testing with them crucial to verifying the ability of the architecture to provide explanations of its decisions in an intuitively understandable way.

As a result, the properties selected for the generation of each label were chosen because they were readily observable by people, easily tested, statistically relevant, and represent either unique spatial or sequence properties of each grouping. These additional labels for the MNIST data were generated based on the presence or absence of open and closed loops in the input image. For instance, a ‘0’ has a closed loop, a ‘3’ has open loops, and a ‘7’ has no loops. This label set was selected to test the ability of the implementation to detect and interpret different physical features within an image, which is a crucial in computer vision problems, and potentially has relevance to other applications such as route analysis. Additionally, labels were generated based on average pixel intensity of the input images, which in this context was driven almost entirely by the area of the digit in each input image. This allows examination of the system's ability to handle object properties like size or color, which is applicable to interpreting sensor information during data fusion or classifying objects during routing. These labels are detailed in Table II.

TABLE II
Decision Hierarchy Label Conditions for MNIST

| Condition | Decision | Value |
|---|---|---|
| LSTM out = 0, 1, 2 | Friendly | L1_label = 0 |
| LSTM out = 3, 6, 7 | Hostile | Ll_label = 1 |
| LSTM out = 4, 5, 8, 9 | Neutral | Ll_label = 2 |
| Ll_label = 0 and closed loop | Assist | L2_label = 0 |
| Ll_label = 0 and no loop | Contact | L2_label = 1 |
| Ll_label = 0 and open loop | Assist | L2_label = 0 |
| Ll_label = 1 and closed loop | Evade | L2_label = 3 |
| Ll_label = 1 and no loop | Engage | L2_label = 2 |
| Ll_label = 1 and open loop | Engage | L2_label = 2 |
| L1_label = 2 | Ignore | L2_label = 4 |
| L1_label = 0 and higher average | Assist | L2_label_alt = 0 |
| L1_label = 0 and lower average | Contact | L2_label_alt = 1 |
| L1_label = 1 and higher average | Evade | L2_label_alt = 3 |
| L1_label = 1 and lower average | Engage | L2_1abel_alt = 2 |
| L1_label = 2 | Ignore | L2_label_alt = 4 |
| L2_label = 0 and top left | Defend | L3_1abel = 1 |
| L2_label = 0 and bottom left | Defend | L3_1abel = 1 |
| L2_1abel = 0 and top right | Escort | L3_1abel = 0 |
| L2_1abel = 0 and top right | Escort | L3_1abel = 0 |
| L2_label = 1 and top left | CloseDistance | L3_1abel = 3 |
| L2_label = 1 and bottom left | CloseDistance | L3_1abel = 3 |
| L2_label = 1 and top right | Transmit | L3_1abel = 2 |
| L2_label = 1 and bottom right | Transmit | L3_1abel = 2 |
| L2_label = 2 and top left | CloseDistance | L3_1abel = 3 |
| L2_label = 2 and bottom left | Strike | L3_1abel = 5 |
| L2_label = 2 and top right | CloseDistance | L3_1abel = 3 |
| L2_label = 2 and bottom right | Strike | L3_1abel = 5 |
| L2_1abel = 3 | IncreaseDistance | L3_1abel = 4 |
| L2_label = 4 | Ignore | L3_1abel = 5 |

A set of labels was also generated based on which quadrant of the image had the highest average pixel intensity. This allowed for the verification that the system could be taught to interpret sequence-specific properties of the data, which has applications to interpreting text, visual, or sensor sequences, as well as to interpreting entity behavior over time in time-series applications. The time series labels allow the system to classify if the target is friendly or hostile in addition to a rudimentary heading of the target.

The preprocessed data is then passed into the feature-extraction subsystem. In this experimental setup, the CNN has three convolutional layers, with a CBAM attention layer using rectified linear unit (ReLU) activation after each convolutional layer, and a maxpooling layer after the second CBAM layer. After the last CBAM layer, the feature data is flattened and a 0.25 dropout is applied.

The flattened feature map output by the CNN is fed into the sequence-interpretation subsystem, which consists of a LSTM with four cells, and uses the sigmoid activation function. The LSTM is followed by a Luong attention layer that calculates the correlation between the output and each step in the input sequence. After the sequence attention values are determined, the output of the final LSTM layer is passed through two dense layers and a final softmax activation function to produce a single classification for the input sequence. Once each sequence is passed through sequence interpretation, the sequence attention matrix is saved as part of the full system attention.

For both the feature-extraction and sequence-interpretation subsystems, the DNN architecture remained unchanged for each dataset except for the shapes of some of the layers as shown in Table III.

TABLE III
Implemented CNN-LSTM Feature-Extraction and
Sequence-Interpretation Subsystems by Layer L

| | | Input Shape | | Kernel Shape | | Output Shape | |
|---|---|---|---|---|---|---|---|
| L | Type | MNIST | Custom | MNIST | Custom | MNIST | Custom |
| 1 | Convol. | 14x14x1 | 28x28x1 | 2x2x8 | 3x3x8 | 12x12x8 | 26x26x8 |
| 2 | CBAM | 12x12x8 | 26x26x8 | N/A | | 12x12x8 | 26x26x8 |
| 3 | Convol. | 12x12x8 | 26x26x8 | 2x2x8 | 3x3x8 | 10x10x8 | 24x24x8 |
| 4 | CBAM | 10x10x8 | 24x24x8 | N/A | | 10x10x8 | 24x24x8 |
| 5 | Maxpool | 10x10x8 | 24x24x8 | 2x2x8 | 3x3x8 | 5x5x8 | 12x12x8 |
| 6 | Convol. | 5x5x8 | 12x12x8 | 2x2x32 | 3x3x32 | 3x3x32 | 10x10x32 |

| | | | | | | |
|---|---|---|---|---|---|---|
| 7 | CBAM | 3x3x32 | 10x10x32 | N/A | 3x3x32 | 10x10x32 |
| 8 | Flatten | 3x3x32 | 10x10x32 | N/A | 288 | 3200 |

| | | | | | |
|---|---|---|---|---|---|
| 9 | LSTM | 4x288 | 4x3200 | N/A | 10 |

| 10 | Dense | 10 | N/A | 50 | |
|---|---|---|---|---|---|
| 11 | Dense | 50 | N/A | 19 | 4 |

Both the output of the sequence-interpretation subsystem and the spatial and sequence attention values are passed to the decision-generation subsystem. The output of the LSTM is fed into the top layer of the decision hierarchy, which then reaches one of three high-level decisions. The determination from the top level is concatenated with the spatial attention matrix and then passed into the second layer to make one of five mid-level decisions. Finally, the sequence attention matrix and output of the second layer are concatenated and passed into the final layer of the decision hierarchy to reach one of seven low-level decisions. This final decision is then passed out as the recommended course of action for the system. The potential decisions that can be made by this implementation of the system were created to simulate a subset of those that would likely be required in real command and control applications. The decision the system arrives at via each layer, or the path it follows through the decision hierarchy, is stored as the system's decision reasoning. This reasoning takes the form of a set of human-comprehendible messages associated with each possible decision. The list of possible decisions and associated messages are shown in Table IV.

TABLE IV
Decision Hierarchy Decisions and Messages

| Layer | Decision | Message |
|---|---|---|
| 1 | Friendly | Entity is friendly. |
| | Hostile | Entity is hostile. |
| | Neutral/Unknown | Entity is neutral or unknown. |
| 2 | Assist | Assist entity. |
| | Contact | Contact entity. |
| | Engage | Engage entity. |
| | Evade | Evade entity. |
| | Ignore | Ignore entity. |
| 3 | Escort | Escort entity. |
| | Defend | Defend entity. |
| | Transmit | Transmit information to entity. |
| | Close Distance | Close distance to entity. |
| | Increase Distance | Increase distance to entity. |
| | Strike | Strike entity. |
| | Ignore | Ignore entity. |

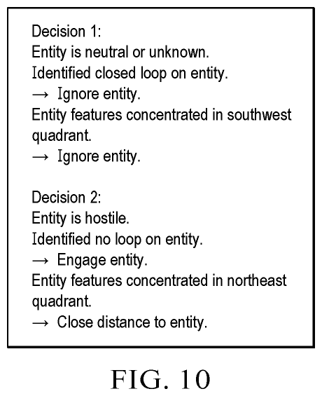

Finally, this embodiment of the system generates a decision explanation based on the combination of system attention and decision reasoning. In the presently described, but non-limiting, form, the explanation-generation subsystem reads in the spatial and sequence attention matrices, the outputs of the DNNs at each layer of the decision hierarchy, and the messages generated by each layer of the decision hierarchy, and produces three outputs. The first two of these are simply the raw attention matrices from the feature-extraction and sequence-interpretation subsystems. The final output contains the human-comprehendible decision explanation. This explanation includes both the messages generated by the decision hierarchy and a set of messages interpreting the system's attention. The interpretation of the system's attention is generated using the outputs of the decision hierarchy's DNNs. Each network is trained to prioritize decisions based on key features in the input sequence. The system determines the presence of these features by analyzing the outputs of the network at each layer and generates interpretation messages based on their perceived presence or absence. An example of these human-comprehendible explanations is shown in FIG. 10.

In certain embodiments of the present disclosure, after a course of action and an explanation is provided to a user (operator) of the decision architecture, the user may communicate a response to a subsystem of the decision architecture, wherein the response is in regard to the course of action and/or the explanation. For example, the user may make a query about the course of action or about the explanation. In one embodiment, for example, the computer may provide an explanation, but the user doesn't understand it and wants an alternative explanation, or wants more details regarding the explanation or the course of action. In such a manner, the user can provide feedback to the decision architecture to better understand or refine the explanation, thereby improving the operation of the system and the quality of the explanations provided to the user.

### IV. Results and Discussion

The CNN-LSTM network was trained over ten epochs using categorical cross entropy as the loss function using an Adam optimizer. Each layer was trained with a learning rate of 0.01.

### A. MNIST-Based Dataset

For the MNIST-based dataset, after ten epochs the network was trained to an average classification accuracy of 94.5% on the validation set. This network was trained 10 separate times under this configuration and in each case the classification accuracy for the validation set ranged from 93% to 95%.

After the network was trained, all values in both the validation and training datasets were run through the trained network and the attention matrices for each set of image sequences were stored. There were three spatial attention matrices generated for each input sequence, one for each convolutional layer in the CNN, and one Luong sequence attention vector from the LSTM. The spatial attention matrices identify which pixels at each layer the system are deemed to be more or less important to the final classification, and the sequence attention vector contains the correlation values between the output and each sequence step. The spatial attention matrix from each CBAM has a depth equal to the number of kernels in the preceding convolutional layer, and the width and height are the same as the output of that preceding layer (8×12×12 for the first CBAM, 8×10×10 for the second, and 32×3×3 for the third), and the sequence attention vector has a single value for each image in the sequence (1×4).

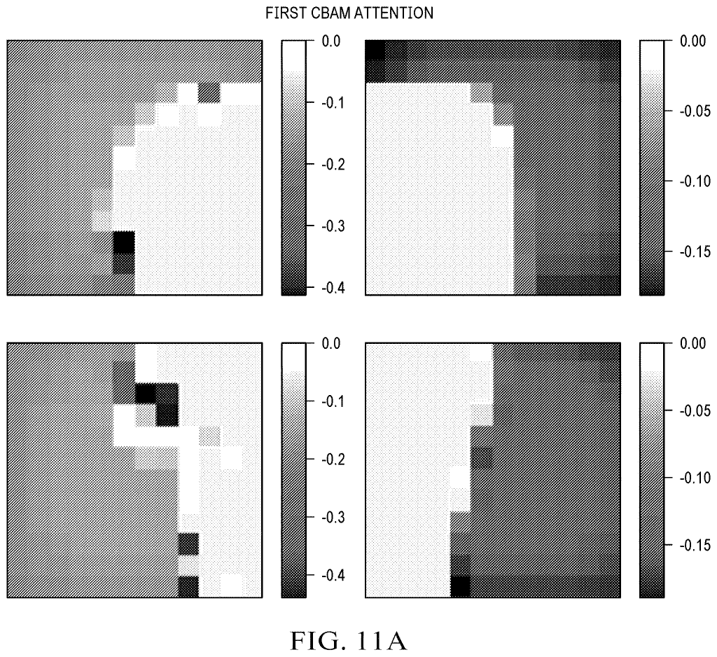

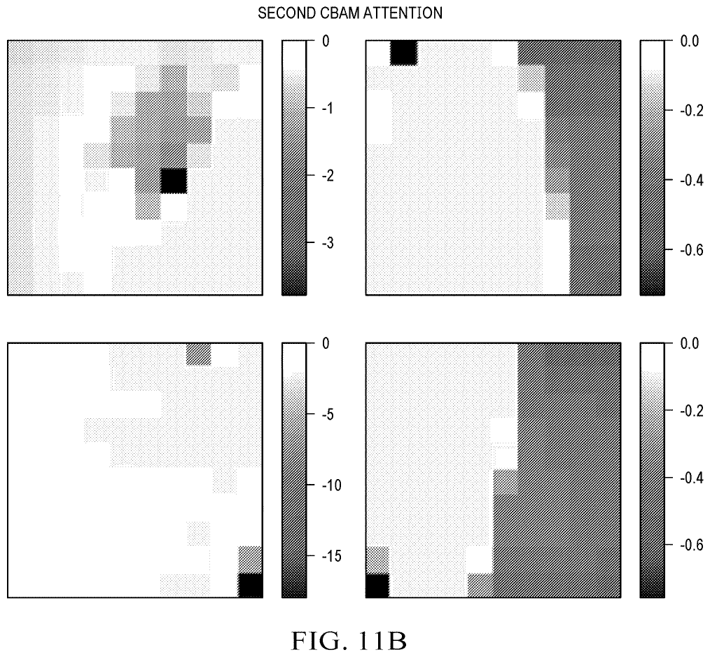

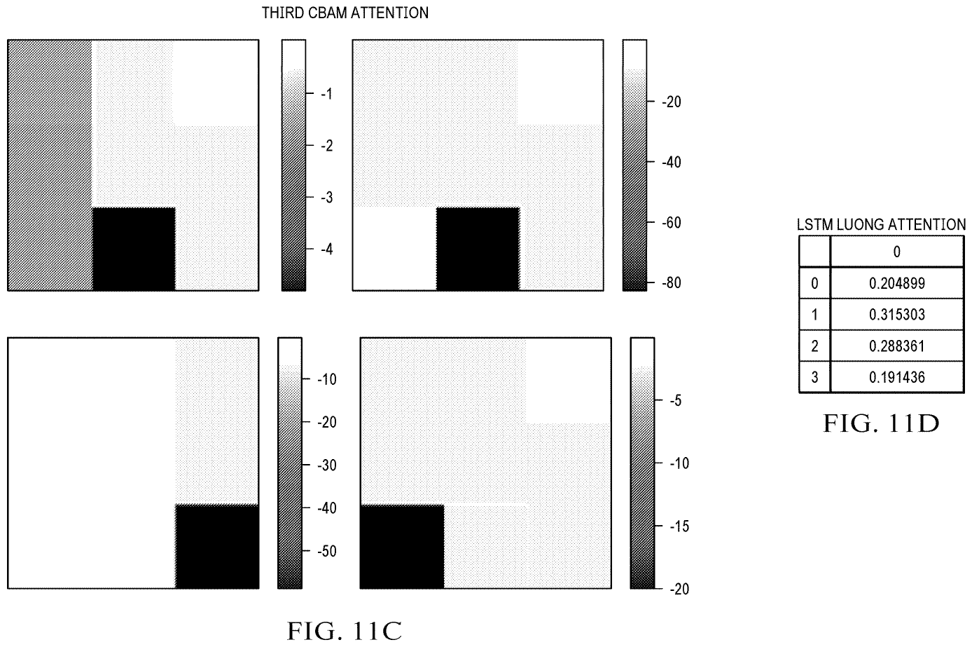

FIGS. 11A-D depict examples of each attention output from the system. For display purposes of the spatial attention matrices, the layers were summed to generate a single matrix containing all relevant features for each sequence sub-image, and that these matrices were arranged side by side in the same configuration as the original MNIST image for ease of viewing. Additionally, they were plotted as heat maps with the python matplotlib viridis color palette to highlight the degree of importance attributed to each pixel by each CBAM. At this stage, testing was performed on the collected attention data to verify that it could be used in a multi-layer perceptron (MLP) to classify data according to only the human-observable features described above. Spatial attention was used to train the MLP to detect the presence of loops in the image and the average pixel intensity of the image, and sequence attention to train it to identify the image quadrant with the highest average pixel intensity.

Additionally, tests were conducted to determine if an MLP using only the spatial attention data could be trained to correctly classify the numeral present on the original image. For tests using spatial attention, the performance of the MLP was examined using attention from each CBAM individually, as well as the combination of attention from all three CBAMs in the system. This allowed for the examination of how well the system could be taught to interpret each level of attention to identify different types of features. In all cases, the system could be trained to recognize the desired features and correctly classify the image sequences based on those observations. For each test case, a two-layer MLP was used with Adam optimization and softmax final activation. These were trained for ten epochs with a learning rate of 0.01.

The representative set of simple test cases allowed for the verification that the system could be trained to interpret both spatial and sequence attention to detect and perform classifications based on readily observable and verifiable features in the original images. The system can be used for other cases, such as the object detection and interpretation of image and sensor data that is often performed in data fusion and interpreting sequence information to recognize object characteristics and behavior, as would be needed for command and control and routing applications.

Through inspection of the spatial attention from each CBAM, various observations can be made about the types of object properties that the feature-extraction subsystem focused on at each convolutional layer.

It is clear from FIGS. 11A-B that earlier layers focus on simpler, more immediately observable properties, such as detecting object edges and distinguishing entities of interest from the background. This makes these layers well suited for training the decision-generation subsystem to identify the presence of objects in a scene and identifying their characteristics. This observation is consistent with the literature and supported by testing, which indicates that the attention from the first CBAM is highly effective at distinguishing between digits based on loop features.

Deeper layers of spatial attention appear to focus on specific points of interest with more abstract object properties. FIG. 11C shows that the third convolutional layer of the CNN focused on the end of the tail of digit 9, as well as the two points at which a sharp curve appears in the loop of the 9. This kind of attention is well suited for teaching the system to interpret the presence of specific object characteristics. This is again supported by both the literature and experiments, which show that the MLP trained with only attention information from the third CBAM performs better than the others at identifying the average pixel intensity in the image and in determining which of the ten digits is present in the image.

These results verified that the system can be trained to interpret what the feature-extraction and sequence-interpretation subsystems of SEDA deemed to be important when making predictions and could generate human-comprehendible explanations of its observations based on that interpretation.

The full system described above was tested. For this testing two configurations of the decision hierarchy were examined. They differed only in the labels and spatial attention values used to train the second layer of the hierarchy. In the first configuration, the hierarchy was trained using the attention values from the first CBAM and the L2 labels, and for the other the hierarchy was trained using the attention values from the third CBAM and the L2 alternate labels (see Table II). In both cases, the final decision accuracy was greater than 90%, and the network accurately generated explanations of its decisions that included both its reasoning and observations like that shown in FIG. 10.

### B. Custom Time-Series Dataset

The time-series data set was used to train the same architecture to classify the four states described above and the CBAM attention maps were captured. Because the time sequences were developed to reveal more target information with each timestep, temporal feature extraction should allow for the system to classify the target without the complete image of the target. As information on the target is gathered over time, the system should reach a point where a classification can be made based on specific features that are uncovered.

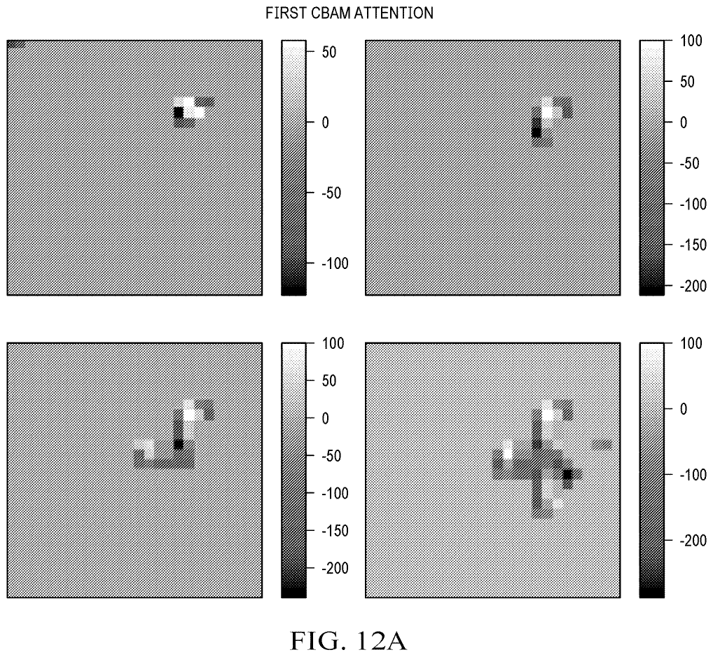

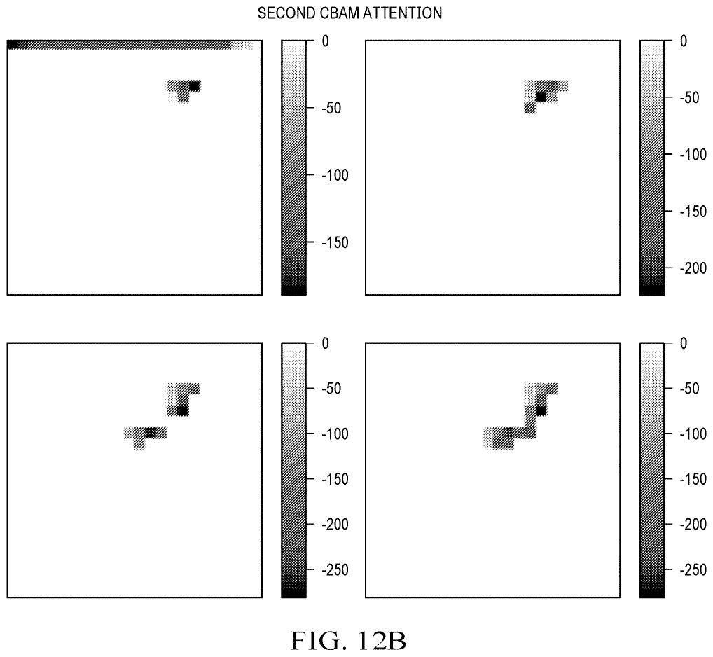

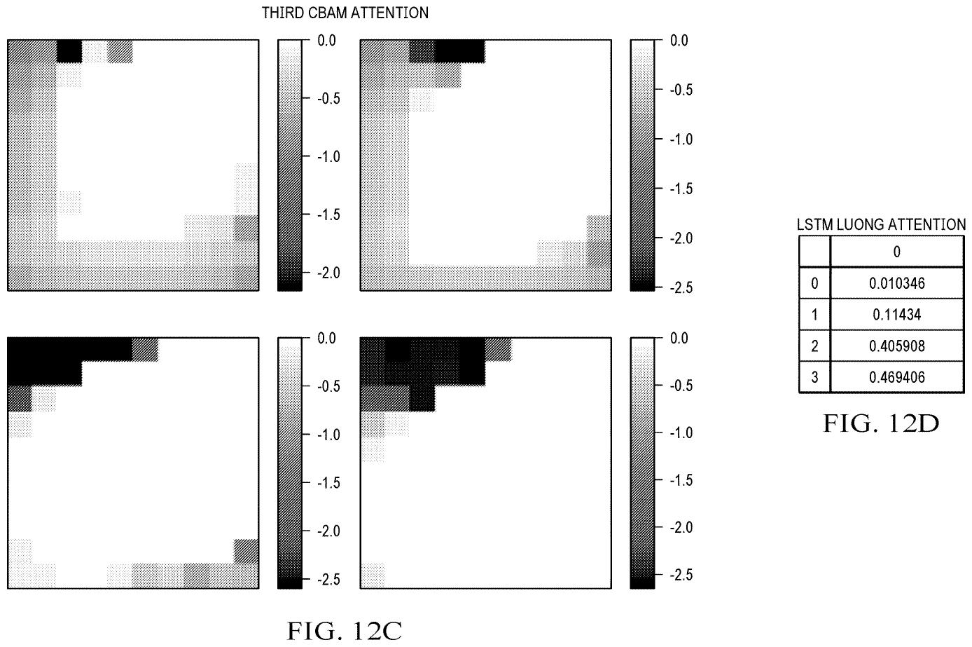

The captured attention maps from each of the CBAMs are shown in FIGS. 12A-12C. The attention maps show that the network is paying attention to pixels that are moving to the lower left. In addition, the Luong attention shows that the network weighted the third and fourth image in the sequence to as high contributors towards the final classification of the target. The Luong attention indicated that the third image of the sequence provided significant information that allowed the system to differentiate the target from other classification possibilities. Upon visual analysis it can be seen that the third image renders the horizontal feature of the cross which allows for the target to be classified as a cross with great confidence. The CBAM attention shows the spatial extraction of the horizontal feature at time step 2. The horizontal feature is unique to the cross and upon detection of the feature, the level of certainty in the Luong attention of the time step 2 is significantly increased. The values of the Luong attention show that the final image in the time series provided enough features to confirm the classification of the cross as the increase in the attention value is less than the increase from time step 1 to time step 2. Conversely, the image in time step 0 does not contain enough features to confidently distinguish the target from an upward chevron. As a result, the spatial CBAM attention detects the feature and updates surrounding pixels as potential pixels of interest. The network does not have enough features to disambiguate the target and reports the temporal certainty of time step 0 to be low relative to the other time steps.

The present disclosure describes the Self-Explaining Decision Architecture (SEDA), which enables intelligent systems to make high fidelity decisions and generate human-comprehendible explanations for those decisions in real time. SEDA accomplishes this by using a combination of attention-based learning and decision mechanisms with an underlying reasoning structure. The embodiment of SEDA disclosed herein comprises an attention-based CNN-LSTM deep neural network and a decision hierarchy. The implementation was tested with both image sequences from the MNIST dataset and a custom time-series simulation developed in Matlab. The testing confirms that the implementation of SEDA can learn to make high fidelity decisions and generate human-comprehendible explanations in real time. Further, the system is able to demonstrate that it can contextualize attention information from the CNN-LSTM network, generating observations that can be intuitively understood by human operators.

SEDA's ability to decide and explain in real time is a new capability valuable to the integration of intelligent systems into mission-critical and safety-critical applications. Shedding light on the otherwise opaque data analysis performed by deep learning systems makes it possible to leverage the strong stochastic optimization capabilities of these systems. This allows human operators to immediately question and understand the reasoning behind an intelligent system's decisions and what it observed that led to that decision. This serves to improve the trust of people impacted by an intelligent agent's decisions, enables more effective human-machine interaction, and allows for rapid identification and correction of problems. SEDA's use of attention to directly infer important contextual information to be used in the generation self-explanations in real time adds significant depth and clarity to the explanations it provides. This is a significant step forward over current uses of attention in interpretability, which focus on purely post-hoc analysis of model predictions. Additionally, the combination of attention and reasoning employed by SEDA strongly emulates the human decision-making process, making those decisions and SEDA's explanations of them highly intuitive.

1.-8. (canceled)

9. A method comprising:
providing a decision architecture, comprising (a) at least one machine learning (ML) model, (b) at least one attention mechanism (AM) integrated into a portion of the at least one ML model, (c) a decision generation system, and (d) an explanation generation system;
using the at least one ML model able to (a) analyze input data and identify patterns within the input data, and (b) provide a pattern output based on the patterns, wherein the pattern output comprises at least one underlying feature;
using the at least one AM to assign a level of certainty to the at least one underlying feature;
using the decision generation system to make a structured decision based on the pattern output, wherein the structured decision includes a course of action to be implemented;
using the explanation generation system to generate an explanation for the structured decision based on the level of certainty, wherein the explanation provides a reason for the course of action, and wherein the explanation is expressed using at least one of a visual mode, an aural mode, a tactile mode, a taste mode, or an olfactory mode; and
implementing the course of action in response to the explanation.

10. The method of claim 9, wherein the course of action is altering an aircraft course.

11. The method of claim 9, wherein the course of action is a medical treatment.

12. The method of claim 9, wherein the decision architecture is a semiautonomous or fully autonomous system.

13. The method of claim 9, wherein the ML model comprises at least one of a feature extraction system or a sequence interpretation system.

14. The method of claim 13, further comprising using the feature extraction system to identify a non-sequential pattern in the input data.

15. The method of claim 14, wherein the non-sequential pattern is a spatial pattern.

16. The method of claim 13, further comprising using the sequence interpretation system to identify a sequential pattern in the input data.

17. The method of claim 16, wherein the sequential pattern is a temporal pattern.

18. The method of claim 9, wherein the structured decision is selected from the group consisting of an inter-related parallel decision, a tiered decision, and a hierarchical decision, and wherein a relationship between decisions can be consistently defined.

19. (canceled)

20. The method of claim 9, further comprising using a subsystem of the decision architecture to receive a response from a user, wherein the response is in regard to the explanation.

21. The method of claim 9, wherein the course of action is a risk-minimizing insurance action.

22. The method of claim 9, wherein the course of action is implemented using a vehicle.

23. The method of claim 9, wherein the course of action is implemented using a power system.

24. The method of claim 9, wherein the course of action is implemented using machinery.

25. A decision architecture for semiautonomous and fully autonomous systems, the decision architecture comprising:
at least one machine learning (ML) model able to (1) analyze input data and identify patterns within the input data, and (2) provide a pattern output based on the patterns, wherein the pattern output comprises at least one underlying feature;
at least one attention mechanism (AM) integrated into a portion of the at least one ML model, wherein the at least one AM is able to assign a level of certainty to the at least one underlying feature;
a decision generation system able to make a structured decision based on the pattern output, wherein the structured decision includes a course of action to be implemented;
an explanation generation system able to generate an explanation for the structured decision based on the level of certainty, wherein the explanation provides a reason for the course of action; and
a subsystem to receive a response from a user, wherein the response is a query in regard to the explanation and is configured to prompt a refined explanation.

26. The decision architecture of claim 25, wherein the ML model comprises at least one of a feature extraction system or a sequence interpretation system.

27. The decision architecture of claim 26, wherein the feature extraction system is able to identify a non-sequential pattern in the input data.

28. The decision architecture of claim 27, wherein the non-sequential pattern is a spatial pattern.

29. The decision architecture of claim 26, wherein the sequence interpretation system is able to identify a sequential pattern in the input data.

30. The decision architecture of claim 29, wherein the sequential pattern is a temporal pattern.

31. The decision architecture of claim 25, wherein the structured decision is selected from the group consisting of an inter-related parallel decision, a tiered decision, and a hierarchical decision, and wherein a relationship between decisions can be consistently defined.

32. The decision architecture of claim 25, wherein the explanation is expressed using at least one of a visual mode, an aural mode, a tactile mode, a taste mode, or an olfactory mode.
